(19) United States
(12) Patent Application Publication
(10) Pub. No.: US 2011/0134148 A1
(43) Pub. Date: Jun. 9, 2011

(54) Systems And Methods Of Processing Touchpad Input

(76) Inventors: William Robert Cridland, Boise, ID (US); Gerold Keith Shelton, Meridian, ID (US); Michael James Shelton, Boise, ID (US); Steven Harold Taylor, Boise, ID (US)

(21) Appl. No.: 12/919,279

(22) PCT Filed: Mar. 11, 2008
(86) PCT No.: PCT/US08/56480

§ 371 Date: Feb. 22, 2011

(51) Int. Cl. G06T 3/20

(52) U.S. Cl. 345/676

(57) ABSTRACT

Systems and methods for processing touchpad input are disclosed. An example method comprises: translating a first position of an object relative to a touchpad into a second position within a selected fixed size input area of a plurality of fixed size input areas; and selecting the fixed input area responsive to an indication of a new input area.

### BACKGROUND

Various software components (e.g., drawing programs, paint programs, handwriting recognition systems) allow users to enter input in a freeform or freehand manner. These components typically allow input via pointing or tracking devices, including both variable-surface-area devices (e.g., mouse, trackball, pointing stick) and fixed-surface-area devices (e.g., touchpads). However, moving a pointer across a large screen requires many movements across the fixed-surface-area device, which is typically small. Also, the button on the device must typically be held down while the pointer is moved, which is difficult to do with one hand. Thus, the conventional fixed-surface-area device is cumbersome to use for freeform input.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 illustrates a touchpad surface and a corresponding display, according to various embodiments disclosed herein.

FIGS. 2A-C illustrate how movement of the object across the touchpad surface is translated by the translation logic, according to various embodiments disclosed herein.

FIG. 3 is a flowchart of a method performed by one embodiment of translation logic 490.

FIG. 4 is a block diagram of a computing device which can be used to implement various software embodiments of the translation logic, according to various embodiments disclosed herein.

### DETAILED DESCRIPTION

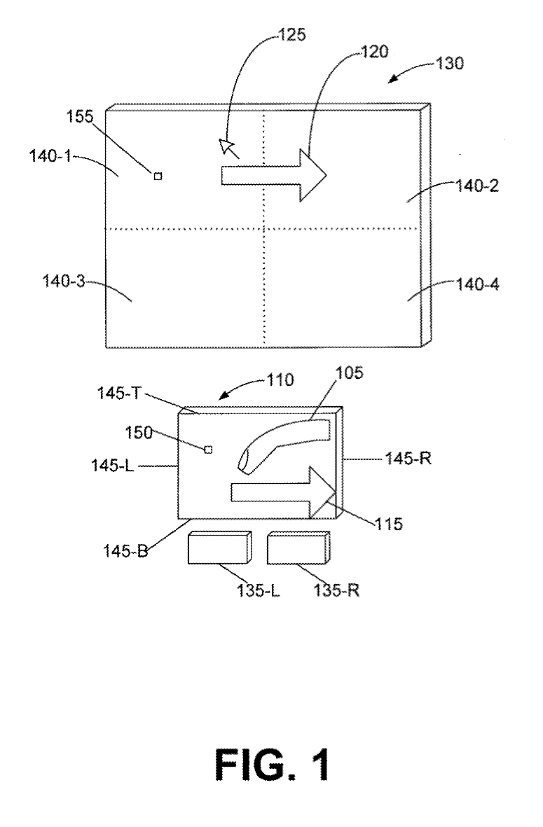

FIG. 1 is a block diagram of a touchpad surface and a corresponding display according to various embodiments disclosed herein. As a user moves an object 105, (e.g., a finger, stylus, or other instrument) across the surface of a touchpad 110, the device driver for touchpad 110 tracks and reports position or position information for object 105 to the operating system. The motion 115 of object 105 across touchpad 110 results in a corresponding motion 120 of a pointer 125 across a portion of display 130. Touchpad 110 also includes one or more buttons 135. The information reported by the device driver for touchpad 110 also includes button state information. One of these buttons (typically the left button 135-R) is used by the operating system to implement selecting and dragging behaviors. Some embodiments of touchpad 110 support a “click lock” option which emulates the user holding down the “drag” button, by reporting the “drag” button as being in an On state as long as the option is enabled. The click lock option can be used in applications such as drawing or painting applications) to draw freehand or freeform.

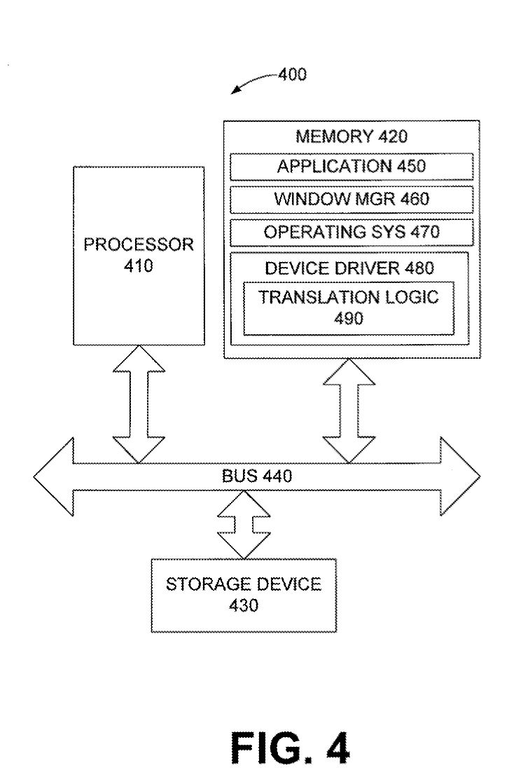

Display 130 is larger than touchpad 110, and comprises multiple adjacent areas. For ease of illustration, FIG. 1 shows four adjacent areas (140-1, 140-2, 140-3, and 140-4), representing only a portion of display 130. Translation logic 490 (shown in FIG. 4) controls operation of touchpad 110. Translation logic 490 uses techniques disclosed herein to map or translate positions on touchpad 110 to positions within one of the multiple adjacent areas 140 (referred to herein as an “input area”). The translation performed by translation logic 490 depends on the current state of touchpad 110, and movement from one touchpad state to another, and thus from one input area 140 to another, depends on transition events.

In some embodiments, the transitions between states/input areas correspond to taps on the edges of touchpad 110. In other embodiments, the transitions between touchpad states correspond to key presses or to button clicks. In still other embodiments, the positioning of the input area is not limited to pre-defined portions. For example, a user may set the input area by double clicking in the center of touchpad 110, then draw a “box” around the desired input area, then double click in the middle again. This drawing of the box may be implemented by the touchpad driver alone or in conjunction with the display driver and/or window manager. Each of these user actions indicates a particular input area. Furthermore, at any point in time, the input area has a fixed size, which is either pre-defined or defined by the user when he sets the input area.

In one example embodiment, touchpad 110 begins in an initial state in which translation logic 490 maps positions on touchpad 110 to the top-left portion (140-1) of display 130. Translation logic 490 moves to a second state upon a double tap at the right edge (145-R) of touchpad 110, where in the second state translation logic 490 maps the positions of object 105 on touchpad 110 to the top-right portion (140-2) of display 130. Similarly, translation logic 490 maps the positions of object 105 on touchpad 110 to the bottom-left portion (140-3) of display 130 while in a third state, and maps to the bottom-right portion (140-4) while in a fourth state.

In some embodiments, this initial state is set through user configuration and/or an application configuration. In other embodiments, a user action such as a specific button click or key press sets the initial state to the center of that portion of display 130 which corresponds to the current position of pointer 125. In other words, adjacent input areas 140 are dynamically constructed by translation logic 490, centered on the current position of pointer 125.

Translation logic 490 operates so that in a given state, the correspondence between touchpad 110 and a particular display area 140 is absolute. That is, a particular relative position 150 on touchpad 110 always maps to an absolute position 155 within the display area 140 associated with the state, where this absolute position is always the same in a given state. If object 105 loses contact with touchpad 110 (e.g., the user lifts his finger) and moves to another position, the mapping performed by translation logic 490 is dependent on the new position and on the touchpad state, but not on the position of pointer 125. This mapping behavior is referred to herein as a “freeform mode” of translation logic 490, since it may be particularly useful for users who are drawing or writing freehand.

In contrast to the freeform mode provided by translation logic 490, a conventional touchpad does consider the position of the pointer when mapping. Moving from the top center of the conventional touchpad to the bottom center does not always result in a pointer that moves from the top center of the screen to the bottom center of the screen. Instead, the pointer moves down (from relative top to relative bottom) from the initial pointer position, wherever that is.

In some embodiments, translation logic 490 also supports this conventional touchpad behavior with a second (“conventional”) mode. In these embodiments, translation logic 490 switches between modes in response to a user action (e.g., a specific key press or button click). In some embodiments, a single user action puts translation logic 490 into freeform mode and also centers the initial input area around the current position of pointer 125 (as described above). In some embodiments, a single user action puts translation logic 490 into freeform mode, centers the initial input area around the current position of pointer 125, and enables the click lock option (described above).

References are made herein to the movement of pointer 125 on display 130 as a result of movement of object 105 across touchpad 110. However, a person of ordinary skill in the art should understand that neither touchpad 110 itself nor the device driver for touchpad 110 draws the pointer on display 130. Instead, touchpad 110 in combination with the device driver for touchpad 110 reports position or position information for object 105, and the operating system, window manager, display driver, or combinations thereof, draw pointer 125 accordingly.

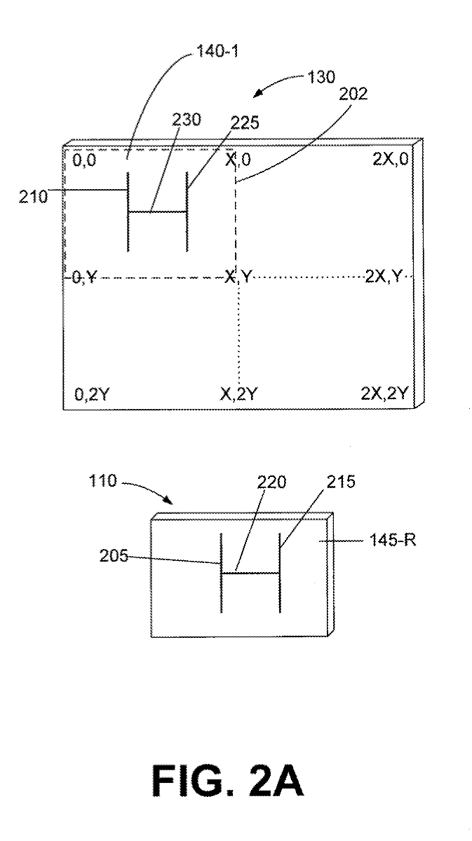

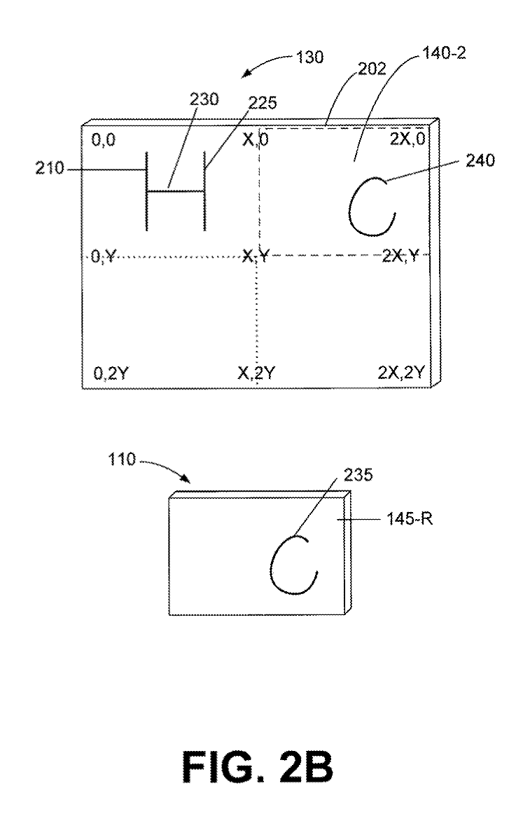

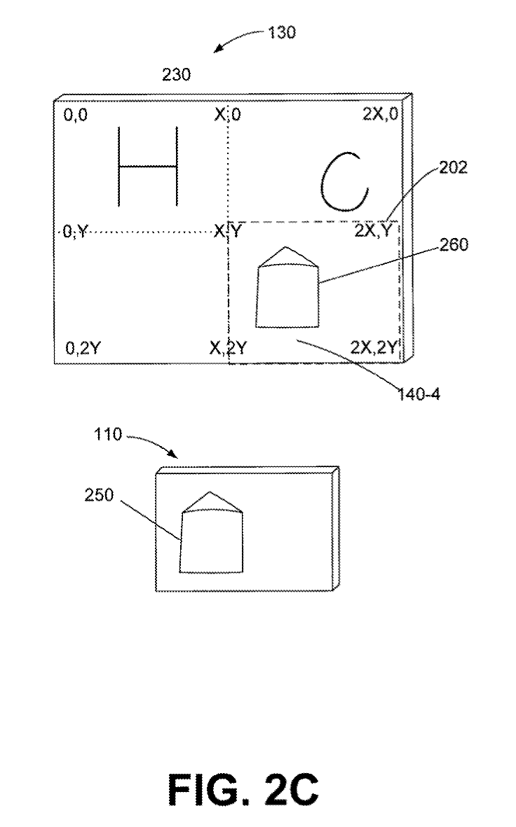

FIGS. 2A-C illustrate a series of movements of object 105 across touchpad 110, and the translation by translation logic 490 of positions on touchpad 110 to positions within various portions of display 130. In this example, coordinates on touchpad 110 range between 0 and X on the X-axis and between 0 and Y on the Y-axis. The coordinates of the entire display 130 range between 0 and 2X on the X-axis, and between 0 and 2Y on the Y-axis, with each portion 140 of display 130 having size X by Y. In this example embodiment, a visual indicator marks the input area, shown in FIGS. 2A-C as a dotted line 202 surrounding the input area. In some embodiments, this input area indicator is produced by the display driver in cooperation with the touchpad driver. In some embodiments, the operating system and/or windowing manager are also involved in producing the input area indicator. In other embodiments, the input area indicator is produced at the application layer using information provided by the touchpad driver.

FIG. 2A represents the initial touchpad state. The input area is the top-left portion (140-1) of display-130, and touchpad positions are mapped to this area. The user forms the letter ‘H’ by first making a motion along path 205. Translation logic 490 translates each position along path 205 into a corresponding position within a display area that is determined by the touchpad state. Here, in the initial state, that display area is 140-1, so path 205 across touchpad 110 is mapped to path 210 in display area 140-1. That is, translation logic 490 translates each position on path 205 to a position on path 210. Formation of the letter ‘H’ continues, with the user creating paths 215 and 220 on touchpad 110, resulting in paths 225 and 230 on display area 140-1.

FIG. 2B represents a second state, entered from the first state in response (for example) to a double tap on the touchpad right edge 145-R. The user forms the letter ‘C’ by moving object 105 along path 235 on touchpad 110. Since touchpad 110 is in the second state, translation logic 490 translates the coordinates of path 235 to corresponding positions within display area 140-2, seen as path 240.

FIG. 2C represents a third state, entered from the second states in response (for example) to a double tap on the lower left corner of touchpad 110. The user draws the freeform shape 250, and translation logic 490 translates the coordinates of shape 250 to corresponding coordinates within display area 140-4, based on the third state, which results in shape 260.

In the example shown in FIGS. 2A-C, each display area 140 is the same size as touchpad 110. Since no size scaling is involved, the process performed by translation logic 490 to translate from a position on touchpad 110 to a position on any display area 140 consists of adding an X and a Y offset to the touchpad position, where offsets are specific to the number and size of display areas. For example, FIGS. 2A-C, the offsets are as follows: (0, 0) when translating into upper-left portion 140-1 (since that portion coincides with touchpad 110); (X,0) when translating into upper-right portion 140-2; (0, Y) when translating into lower-left portion 140-3; and (X,Y) when translating into lower-right portion 140-4. Thus, this translation can be generalized as [0+(nₓ−1)*X, 0+(n_{y}−1)*Y], where nₓ is an integer between 0 and the number of areas in the X direction and n_{y} is an integer between 0 and the number of areas in the Y direction.

In other embodiments, the size of display areas 140 is different than the size of touchpad 110, so translation logic 490 uses scaling during the translation. The scaling may be linear or non-linear, as long as the same scale is used.

Some embodiments of translation logic 490 support user-initiated transitions such as those described above (e.g., taps on touchpad 110, key presses, button clicks). In some embodiments of translation logic 490, transitions occur automatically upon an indication of a new input area. In one embodiment, the indication corresponds to user input approaching the edge of a display area 140. For example, translation logic 490 may automatically transition to the next display area to the right as user input approaches the right edge of the current input area. When the right-most area has been reached, translation logic 490 may transition automatically to the left-most display area that is below the current area. Such an embodiment may be useful when the user is entering text which will be recognized through handwriting recognition software.

Various implementation options are available for this automatic transition. These options can be implemented in software, for example in the touchpad driver alone or in conjunction with the display driver and/or window manager. In one embodiment, after the drawing eclipses an adjustable boundary on the edge of touchpad 110, software automatically transitions to the next area when contact with the touchpad 110 is lost (e.g., user lifted his finger or stylus). Delays may be introduced in the transition so that actions such as dotting the letter ‘i’ are not treated as a transition. Some embodiments allow the user to enable and disable the automatic transition feature, and to configure the adjustable boundary and/or the delay may be user configurable.

In another embodiment, the automatic transition occurs whenever contact with the touchpad 110 is lost. With this option, there is no hand movement across touchpad 110 while writing, just character entry in touchpad area. Such embodiments may scale the size of the window on display 130 to the size of the characters that were being entered, so that the characters do not look unusual because they are spaced too far apart.

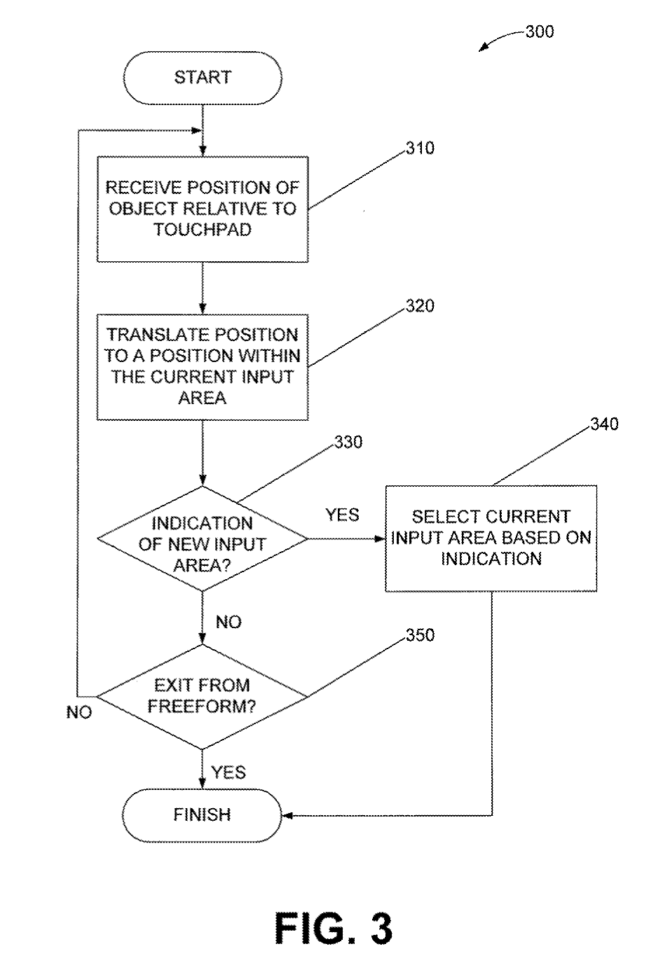

FIG. 3 is a flowchart of a method performed by one embodiment of translation logic 490. Process 300 executes when translation logic 490 is in “freeform mode” (described above) to process a received position of object 105. Processing begins at block 310, where a position of object 105 relative to touchpad 110 is received. Next, at block 320 the position is translated to a new position within a fixed size area that is associated with the current input area (140). At block 330, process 300 checks for an indication of a new input area (140). If a new input area is not indicated, processing continues at block 350, which will be discussed below. If a new input area is indicated, processing continues at block 340, where the current input area is set to the new input area. In some embodiments, a state variable is updated to track the current input area. After setting the new input area, processing continues at block 350. At block 350, process 300 determines whether or not the user has exited from freeform mode. If not, processing repeats, starting with block 310. If freeform mode has been exited, process 300 is complete.

In the embodiment of FIG. 3, process 300 is an event handler executed for each change in position while in freeform mode, and the event handler performs the translation described herein. When the user transitions from freeform mode to conventional mode, a different (conventional) event handler is executed instead. Thus, the freeform event handler need not check for a change of mode. In another embodiment, the input area indication is handled as an event also, so the freeform event handler need not check for such an indication, but simply translate according to the current input area or state. A person of ordinary skill in the art should appreciate that polled embodiments which process received input in a loop are also contemplated. Some polled embodiments also poll for indications of a new input area and/or

Translation logic 490 can be implemented in software, hardware, or a combination thereof. In some embodiments, translation logic 490 is implemented in hardware, including, but not limited to, a programmable logic device (PLD), programmable gate array (PGA), field programmable gate array (FPGA), an application-specific integrated circuit (ASIC), a system on chip (SoC), and a system in package (SiP). In some embodiments, translation logic 490 is implemented in software that is stored in a memory and that is executed by a suitable microprocessor, network processor, or microcontroller situated in a computing device.

FIG. 4 is a block diagram of a computing device 400 which can be used to implement various software embodiments of translation logic 490. Computing device 400 contains a number of components that are well known in the computer arts, including a processor 410, memory 420, and storage device 430. These components are coupled via a bus 440. Omitted from FIG. 4 are a number of conventional components that are unnecessary to explain the operation of computing device 400.

Memory 420 contains instructions which, when executed by processor 410, implement translation logic 490. Software components residing in memory 420 include application 450, window manager 460, operating system 470, touchpad device driver 490, and translation logic 490. Although translation logic 490 is shown here as being part of device driver 490, translation logic 490 can also be implemented in another software component, or in firmware that resides in touchpad 110.

Translation logic 490 can be embodied in any computer-readable medium for use by or in connection with an instruction execution system, apparatus, or device. Such instruction execution systems include any computer-based system, processor-containing system, or other system that can fetch and execute the instructions from the instruction execution system. In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) an optical fiber and a portable compact disk read-only memory (CD-ROM).

The flow charts herein provide examples of the operation of translation logic 490, according to embodiments disclosed herein. Alternatively, these diagrams may be viewed as depicting actions of an example of a method implemented in translation logic 490. Blocks in these diagrams represent procedures, functions, modules, or portions of code which include one or more executable instructions for implementing logical functions or steps in the process. Alternate embodiments are also included within the scope of the disclosure. In these alternate embodiments, functions may be executed out of order from that shown or discussed, including substantially concurrently or in reverse order, depending on the functionality involved. Not all steps are required in all embodiments.

What is claimed is:

1. A method comprising:
translating a first position of an object relative to a touchpad into a second position within a selected fixed size input area of a plurality of fixed size input areas; and
selecting the fixed input area responsive to an indication of a new input area.

2. The method of claim 1, further comprising:
reporting the second position.

3. The method of claim 1, the selected fixed size input area corresponding to a portion of a display.

4. The method of claim 1, the indication comprising a double tap on the touchpad.

5. The method of claim 1, the indication comprising user input approaching the edge of the selected fixed size input area.

6. The method of claim 1, the indication comprising the object losing contact with the touchpad.

7. The method of claim 1, the indication comprising one of a plurality of user actions, each of the user actions indicating one of the plurality of fixed size input areas.

8. A method comprising:
in a first state, tracking movement of an object across a touchpad as a first set of positions relative to the touchpad;
in the first state, translating the first set of positions to a corresponding first set of absolute positions, each first absolute position within a first fixed size area;
in a second state, tracking movement of the object across the touchpad as a second set of positions relative to the touchpad;
in the second state, translating the second set of positions to a corresponding second set of absolute positions, each first absolute position within a second fixed size area; and
transitioning from the first state to a second state upon an indication of the second input area of fixed size.

9. The method of claim 8, the first input area corresponding to a first portion of a display.

10. The method of claim 8, the indication comprising a double tap on the touchpad.

11. The method of claim 8, the indication comprising user input approaching the edge of the first input area.

12. The method of claim 8, the indication comprising the object losing contact with the touchpad.

13. The method of claim 8, further comprising:
displaying a visual indicator that marks the first input area.

14. A computer system comprising:
a touchpad;
translation logic configured to:
in a first state, translate a first set of movements of an object across the touchpad to a corresponding first set of movements within a first input area of fixed size;
in a second state, translate a second set of movements of the object across the touchpad to a corresponding second set of movements within a second input area of fixed size; and
transition from the first state to a second state upon an indication of the second input area of fixed size.

16. The system of claim 14, wherein the translation logic is further programmed to:
report the first set of movements.

17. The system of claim 14, the first input area corresponding to a first portion of a display.

18. The system of claim 14, the indication comprising a double tap on the touchpad.

19. The system of claim 14, the indication comprising user input approaching the edge of the first input area.

20. The system of claim 14, the indication comprising the object losing contact with the touchpad.
